(19) United States
(12) Patent Application Publication
(10) Pub. No.: US 2017/0297161 A1
(43) Pub. Date: Oct. 19, 2017

(54) MACHINING DEVICE

(71) Applicant: HOMAG GMBH, Schopfloch (DE)

(72) Inventors: Hartmut AMOS, Rottenburg (DE); Volker SCHMIEDER, Mössingen (DE)

(73) Assignee: HOMAG GMBH, Schopfloch (DE)

(21) Appl. No.: 15/512,678

(22) PCT Filed: Sep. 8, 2015
(86) PCT No.: PCT/EP2015/070509

§ 371 Date: Mar. 20, 2017

(30) Foreign Application Priority Data
Sep. 22, 2014 (DE) 10 2014 219 060.6

(51) Int. Cl. B23Q 39/02; B23Q 1/01; B23Q 3/157; B27C 9/04

(52) U.S. Cl. CPC B23Q 39/023; B27C 9/04; B23Q 1/012; B23Q 3/15786

(57) ABSTRACT

The invention relates to a machining device, in particular for machining workpieces consisting of wood, wood products, plastics or similar, said device comprising a workpiece holder for holding a workpiece during the machining, process, and a guide means for displaceably guiding a tool carriage for holding and driving a tool, the workpiece holder and/or the guide means being displaceable by displacement means in order to produce relative movement in a machining direction between the workpiece and the tool, for the machining of the workpiece. The workpiece carriage is displaceably arranged on one side of the guide means and the workpiece carriage supports two tools on one side of the guide means and in the machining direction of the workpiece, said tools being arranged next to one another.

### TECHNICAL FIELD

The invention relates to a machining device, in particular for machining workpieces made of wood, wood materials, plastics material or the like, in particular according to the preamble of claim 1.

### PRIOR ART

Machining devices for machining workpieces are widely known from the prior art. Such machining devices usually have a workpiece holder by means of which a workpiece is arrange le and fastenable. Such workpiece holders can be configured in a stationary or movable manner, and so they can be formed for example by a workpiece table or by movable workpiece slides or the like. Furthermore, such machining devices often comprise a gantry or extension arm on which tools for machining the workpiece are provided. In that case, either the workpiece can be provided to move past the tool or vice versa, such that a relative movement between the tool and workpiece is provided and exploited in order for it to be possible to machine the workpiece for example along a side or edge.

In this case, gantry devices are also known in which a tool slide is moved through the gantry to which the workpiece is fastened, in order to machine the workpiece for example in continuous operation. Gantry installations of the type in which a tool for machining the workpiece is displaceable on one side of the gantry by way of a tool slide in order to be able to take up different tool positions are known, such that, depending on the tool and workpiece used, the tool can be set into a different position when the workpiece is guided past. It is also possible for the tool to be displaced by means of the tool slide during the machining operation in order to produce a corresponding contour on the workpiece.

However, when a tool is arranged on a tool slide arranged on one side of the gantry, there is still room for improvement as regards the machining capacity. Therefore, gantry devices have become known which have, on both sides of the gantry, a displaceable tool slide for the arrangement of and for moving a respective tool. As a result, the workpiece can be moved past both tools in succession, and so two machining steps can be carried out directly in one pass.

In this case, the spacing of the central axes of the tools is at least about 1.2 m on account of the dimensions of the gantry and of the tools themselves, and so the desired. increase in efficiency is achieved substantially only for workpieces which are longer than this spacing. For workpieces which are shorter than this spacing, double procedure at a tool would produce the same machining efficiency.

### SUMMARY OF THE INVENTION, PROBLEM, SOLUTION, ADVANTAGES

The problem addressed by the invention is that of creating a machining device which entails a considerable increase in machining efficiency even in the case of shorter workpieces.

This problem is solved by the features of claim 1.

One exemplary embodiment of the invention relates to a machining device, in particular for machining workpieces made of wood, wood materials, plastics material or the like, having a workpiece holder for holding a workpiece during machining, having a guide means for the displaceable guiding of a tool slide for holding and moving a tool arranged. thereon, wherein the workpiece holder and/or the guide means are displaceable by means of displacement means in order to create a relative movement in a machining direction between the workpiece and the tool for machining the workpiece, wherein the tool slide is arranged in a displaceable manner on one side of the guide means and the tool slide bears two tools alongside one another on one side of the guide means and in the machining direction of the workpiece. As a result, the spacing of the tools from one another can be reduced greatly, and so simultaneous machining with both tools is worthwhile even in the case of relatively short workpieces and entails a time advantage. As a result, both the tools arranged on the one tool slide are in use at the same time in order to simultaneously machine a workpiece guided past the two tools in the machining direction in one working step by way of both tools.

It is particularly advantageous for the two tools to be movable together in a first direction perpendicular to the machining direction by means of the tool slide. As a result, the machining of the workpiece can take place even in the case of workpieces with different widths, when the tools can be displaced jointly in the first direction. In this case, the first direction is advantageously oriented perpendicularly to the machining direction and in particular transversely or horizontally with respect thereto.

It is particularly advantageous for at least one of the tools or both tools to each. be arranged on a secondary slide, wherein the secondary slide(s) is or are arranged on the tool slide such that the tool is movable in a second direction perpendicular to the first direction and perpendicular to the machining direction. As a result, setting or fine adjustment in a further direction can still take place in order for it to be possible to also machine further or additional regions of the workpiece.

It is particularly advantageous for at least one of the tools or both tools to each be arranged on a secondary slide, wherein the secondary slide(s) is or are arranged on the tool slide such that the tool is movable in the first direction. As a result, the tool(s) can still be adjusted relative to one another or to the workpiece. One tool or both tools can thus be moved or set in the first direction relative to the tool slide. Thus, it is also possible for one tool to be adjusted on the tool slide in the first direction relative to the second tool.

It is particularly advantageous for a respective drive arrangement having a tool receptacle to be arranged on the tool slide or on the secondary slide(s), in order to receive and drive in each case one machining tool. In this case, the machining tool is a tool which serves to machine the surface of the workpiece or the volume of the workpiece. Particularly advantageously, different tools of this type can be used, which are removed for example from a tool magazine following appropriate selection of the tool and are deposited there again after use.

It is also advantageous for the drive arrangement to be in the form of a spindle unit, such as in particular of a 4-axis or 5-axis spindle unit. As a result, it is also possible to introduce complex structures into the workpiece by means of the tool.

It is also advantageous for the tool to be a cutting tool, such as in particular a milling tool, a drilling tool or a sawing tool.

It is also advantageous for the guide means to be in the form of a stationary gantry or of a stationary extension. arm and for the workpiece holder to be configured to be displaceable by means of a drive and guide means and guide the workpiece in a displaceable manner. In this case, the workpiece holder can be movable through the gantry or under the extension arm in order for it to be possible to machine the workpiece by means of the displaceable tool on the guide means.

It is particularly advantageous for the guide means to be in the form of a displaceable gantry or of displaceable extension arm and for the workpiece holder to be in the form of a stationary workpiece table. In this case, the gantry or the extension arm can be movable over the workpiece holder in order for it to be possible to machine the workpiece by means of the displaceable tool on the guide means.

In the case of the device according to the invention, it is also advantageous for two tools to removable simultaneously from a tool magazine and to be insertable into the tool slide into corresponding tool receptacles, such that a time advantage can be achieved in this regard, too.

Further advantageous configurations are described by the following description of the figures and by the dependent claims.

### BRIEF DESCRIPTION OF THE DRAWINGS

The invention is explained in more detail in the following text on the basis of at least one exemplary embodiment with reference to the drawings, in which:

FIG. 1 shows a schematic illustration of a first exemplary embodiment according to the invention of a machining device, and

FIG. 2 shows a schematic illustration of a first exemplary embodiment according to the invention of a machining device.

### PREFERRED EMBODIMENT OF THE INVENTION

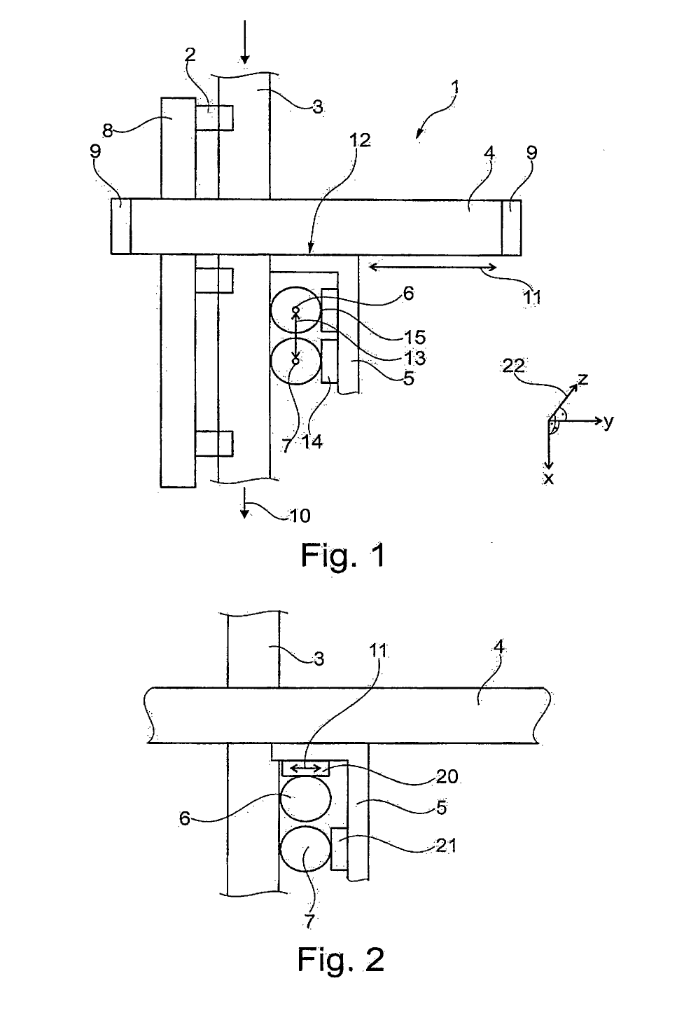

FIG. 1 shows a machining device 1, in particular for machining workpieces made of wood, wood materials, plastics material or the like. The machining device 1 has a workpiece holder 2 by means of which workpieces 3 can be held for machining.

The machining device also has a guide means 4 for displaceably guiding a tool slide 5, in order to hold and move a first tool 6 and a second tool 7.

In this case, the workpiece holder 2 and/or the guide means 4 are configured to De displaceable by means of displacement means 8, 9, in order to produce a relative movement in a machining direction 10 between the workpiece 3 and the first and the second tool 6, 7 in order to machine the workpiece in the machining direction.

FIG. 1 shows that the tool slide 5 is arranged on one side 12 of the guide means 4 so as to be displaceable, for instance shiftable in the direction 11. According to the invention, the tool slide 5 bears two tools 6, 7 alongside one another on one side 12 of the guide means 4 and in the machining direction 10 of the workpiece.

This means that the spacing of the tools can be kept small, for example can be kept in the region of about 40 cm. In this case, the spacing is the axial spacing 13 of the tools 6, 7.

As a result of being arranged on the tool slide, the two tools 6, 7 are arranged so as to be movable jointly in a first direction 11 perpendicular to the machining direction 10 by means of the tool slide 5. In this case, the first direction is typically the y direction while the machining direction is the x direction.

Provided on the tool slide are secondary slides 14, 15. In this case, at least one of the tools 6, 7 is, or both of the tools 6, 7 are each arranged on a secondary slide 14, 15, wherein the secondary slide(s) 14, 15 is or are arranged on the tool slide 5 such that the tool 6, 7 is movable in a second direction perpendicular to the first direction 11 and perpendicular to the machining direction 10. In this case, the second direction 22 is, the z direction, which is perpendicular to the plane defined by the first direction 11 and the machining direction 10.

FIG. 2 shows a further exemplary embodiment in which two tools 6, 7 are likewise arranged on the tool slide 5, said tools 6, 7 each being arranged in a displaceable manner on secondary slides 20, 21. In this case, at least one of the tools is, or both of the tools are each arranged on a secondary slide 20, 21, wherein at least one of the secondary slides, or the secondary slides is or are arranged on the tool slide 5 such that the tool 6, 7 is also movable in the first direction. Thus, in the exemplary embodiment in FIG. 2, the secondary slide 20 is embodied such that a movement in. the first direction 11 is also possible. In this case, the secondary slides are also configured such that the tools are also displaceable in the second direction. As a result of the adjustment of the tool 6 in the first direction 11 with at least a small travel, the penetration depth of the tool 6 into the workpiece can be controlled individually. In this case, the penetration depth of the other tool 7 can be effected by the position of the tool slide 5.

In both exemplary embodiments, it is advantageous for a respective drive arrangement having a tool receptacle to be arranged on the tool slide 5 or on the secondary slide(s) 14, 15, 20, 21, in order to receive and drive a respective tool 6, 7 for machining the workpiece 3. In this case, the drive arrangement is in the form of a simple drive spindle or of a spindle unit, such as in particular a 4-axis or 5-axis spindle unit.

According to the invention, the respective tool 6, 7 is a cutting tool, such as in particular a milling tool, a drilling tool or a sawing tool. Edge machining devices for applying edge material or for finishing applied edge material are not explicitly intended to be considered tools, rather only tools which machine the workpiece itself by cutting.

Depending on the configuration of the machining device 1, the guide means 4 can be is the form of a stationary gantry or of a stationary extension arm. In this case, it is advantageous for the workpiece holder 2 to be configured so as to be displaceable by means of displacement means 8, such as a drive and guide means, and as a result displaceably guide and displace the workpiece 3.

Alternatively, the guide means 4 can be in the form of a displaceable gantry or of a displaceable extension arm which is displaceable with the displacement means 9, wherein it would be advantageous for the workpiece holder 2 to be in the form for example of a stationary workpiece table.

As a result, it is in each case possible for the workpiece 3 to be able to be guided easily and efficiently past the two tools 6, 7 in the machining direction 10, in order to machine the workpiece.

### LIST OF REFERENCE SIGNS

1 Machining device

2 Workpiece holder

3 Workpiece

4 Guide means

5 Tool slide

6 Tool

7 Tool

8 Displacement means

9 Displacement means

10 Machining direction

11 first direction

12 Side

13 Axial spacing

14 Secondary slide

15 Secondary slide

20 Secondary slide

21 Secondary slide

22 Second direction

1. A machining device, in particular for machining workpieces made of wood, wood materials, plastics material or the like, having a workpiece holder for holding a workpiece during machining, having a guide means for the displaceable guiding of a tool slide for holding and moving a tool, wherein the workpiece holder and/or the guide means are displaceable by means of displacement means in order to create a relative movement in a machining direction between the workpiece and the tool for machining the workpiece, wherein the tool slide is arranged in a displaceable manner on one side of the guide means and the tool slide bears two tools alongside one another on one side of the guide means and in the machining direction of the workpiece.

2. The machining device as claimed in claim 1, wherein the two tools are movable together in a first direction perpendicular to the machining direction by means of the tool slide.

3. The machining device as claimed in claim 1, wherein at least one of the tools or both tools is or are each arranged on a secondary slide, wherein the secondary slide(s) is or are arranged on the tool slide such that the tool is movable in a second direction perpendicular to the first direction and perpendicular to the machining direction.

4. The machining device as claimed in claim 1, wherein at least one of the tools or both tools is or are each arranged on a secondary slide, wherein the secondary slide(s) is or are arranged on the tool slide such that the tool is movable in the first direction.

5. The machining device as claimed in claim 1, wherein a respective drive arrangement having a tool receptacle is arranged on the tool slide or on the secondary slide(s), in order to receive and drive in each case one tool.

6. The machining arrangement as claimed in claim 5, wherein the drive arrangement is in the form of a spindle unit, such as in particular of a 4-axis or 5-axis spindle unit.

7. The machining device as claimed in claim 1, wherein the tool is a cutting tool, such as in particular a milling tool, a drilling tool or a sawing tool.

8. The machining device as claimed in claim 1, wherein the guide means is in the form of a stationary gantry or of a stationary extension arm and the workpiece holder is configured to be displaceable by means of a drive and guide means and guides the workpiece in a displaceable manner.

9. The machining device as claimed in claim 1, wherein the guide means is in the form of a displaceable gantry or of a displaceable extension arm and the workpiece holder is in the form of a stationary workpiece table.

10. The machining device as claimed in claim 1, wherein two tools are removable simultaneously from a tool magazine and are insertable into the tool slide into corresponding tool receptacles.
